(19) United States
(12) Patent Application Publication
(10) Pub. No.: US 2006/0081670 A1
(43) Pub. Date: Apr. 20, 2006

(54) Reinforced ski bag

(75) Inventors: Wolfgang Sitzler, Wuppertal (DE); Hartmut Bohlke, Wuppertal (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: BOS GmbH & Co. KG, Ostfildern (DE)

(21) Appl. No.: 11/250,714

(22) Filed: Oct. 13, 2005

(30) Foreign Application Priority Data
Oct. 14, 2004 (DE) 10 2004 050 272.2

(51) Int. Cl. B60R 11/00; B65D 85/20

(52) U.S. Cl. 224/572; 206/315.1; 224/917; 224/917.5

(57) ABSTRACT

The present invention provides a ski bag having a reinforcing element in at least one region. This reinforcing element prevents the steel edges of the skis from cutting open the ski bag in the event of a crash such that parts cannot be thrown into the passenger compartment through the ski bag or the skis cannot be thrown into the passenger compartment through this opening.

### FIELD OF THE INVENTION

The present invention relates to a bag arrangement for stowing skis in a motor vehicle.

### BACKGROUND OF THE INVENTION

A method for stowing skis in passenger cars is known, for example, from DE 196 04 714 A1. With the method disclosed in that reference, the skis are placed in a ski bag. The ski bag is secured in the motor vehicle with the aid of belt bands. The ski bag lies in the cargo area of a station wagon, wherein the cargo area is enlarged accordingly by folding over the rear bench seat. The bands or belts are anchored in the seat belt locks. According to another method, a ski bag is utilized that extends into the interior of the motor vehicle from the seat back of the rear bench seat. Such a ski bag is described, for example, in DE 195 13 213 A1 or DE 44 38 909 A1. With this type of ski bag, the skis are inserted into the ski bag from the trunk.

During a rear-end collision, the skis exert a significant force upon the bag casing and the belt that anchors the ski bag in the motor vehicle. Depending on how the skis are packed into the ski bag, the very sharp steel edges of the skis may be pressed against the bag casing with such a high force that they cut open the bag cover and/or sever the belt. Parts could be discharged into the passenger compartment through the opening in the bag or both skis could penetrate into the passenger compartment and endanger the passengers.

### BRIEF SUMMARY OF THE INVENTION

In view of the foregoing, a general object to the present invention is to provide a ski bag arrangement that is less susceptible to being cut open by the steel edges of skis.

To this end, the ski bag arrangement of the present invention can comprise a bag casing of a flexible material. The bag casing contains an insertion opening for inserting the skis into the bag. At the opposing end, the bag casing is closed with a bottom.

In order to enhance the safety of the ski bag in a crash, the ski bag arrangement is provided with a reinforcing element that is resistant to being cut by the steel edges. The cut-resistant reinforcing element can have a variety of different arrangements and dimensions. For example, the reinforcing element can be arranged on each side of the bag casing, against which the steel edges of the stowed skis are pressed in the normal operating position during a crash. In this respect, the reinforcing element does not necessarily have to be arranged over the entire circumference of the bag casing. The reinforcing element can extend over the entire circumference of the ski bag or arranged only in a certain circumferential region. Because of the high surface pressure occurring at the bottom region of the ski bag, it can be advantageous to utilize the reinforcing element at that location. The reinforcing element also can be arranged in several regions that are spaced apart from one another and adjacent to one another in the axial direction. The axial length of the reinforcing element can be limited to no more than 2% of the total axial length of the bag casing.

The cut-resistant reinforcing element can comprise a cut-resistant synthetic fiber or monofilament, preferably a Kevlar fiber. The Kevlar fiber can extend in the circumferential direction in the bag casing. The Kevlar fiber or the monofilament can be directly incorporated into the bag casing, for example, in the form of a warp or weft thread depending on whether the warp or the weft thread of the fabric extends in the circumferential direction. A warp knit fabric that also contains a synthetic fiber of corresponding strength can be used in the bottom region of the ski bag. Another configuration for the cut-resistant reinforcing element can be a chain, the individual links of which consist of wire. In this arrangement, the free ends of the wire chain links are coiled around the chain between the chain links.

The cut-resistant reinforcing element also can be inseparably connected to the bag casing. However, it also can be in the form of a belt that surrounds the bag casing. This belt can be detachable from or be inseparably connected to the bag casing.

Instead of configuring the bag casing or the material of the bag casing in a more cut-resistant fashion, it is also possible to provide a cut-resistant region in the belt that secures the bag casing in the motor vehicle. For example, a chain or a cut-resistant monofilament can be inserted or woven into the belt in the same way as previously described with regard to a reinforcing element in the bag casing. In case of a woven belt, it is practical to arrange the thread in the warp direction. This eliminates the need to produce additional tubular pockets, into which the thread(s) is/are subsequently inserted.

While reading through the following description of the figures, it becomes clear that the invention can be modified in different ways. These modifications are quite obvious to a person skilled in the art and consequently require no detailed description.

### DETAILED DESCRIPTION OF THE INVENTION

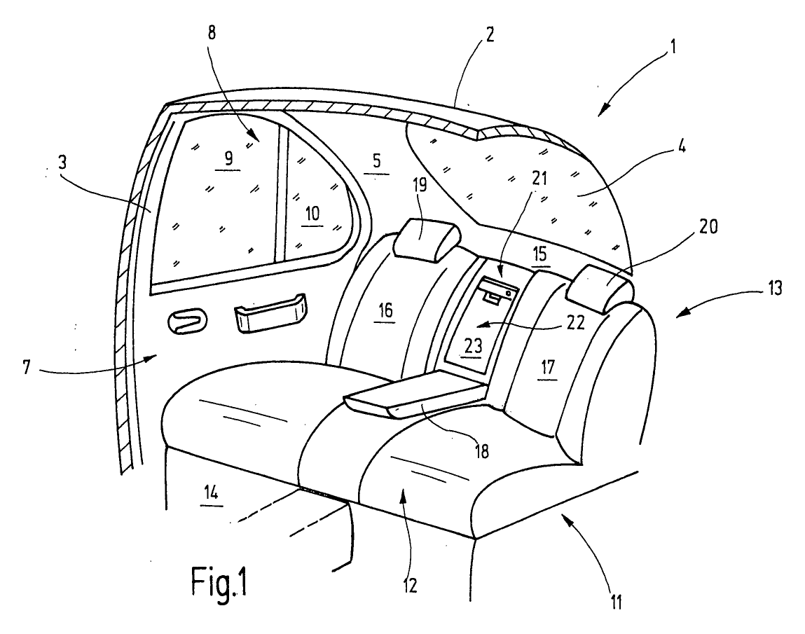

FIG. 1 is a partially cutaway diagrammatic perspective view of an exemplary rear passenger compartment section of a motor car that contains a ski bag arrangement according to the present invention arranged therein;

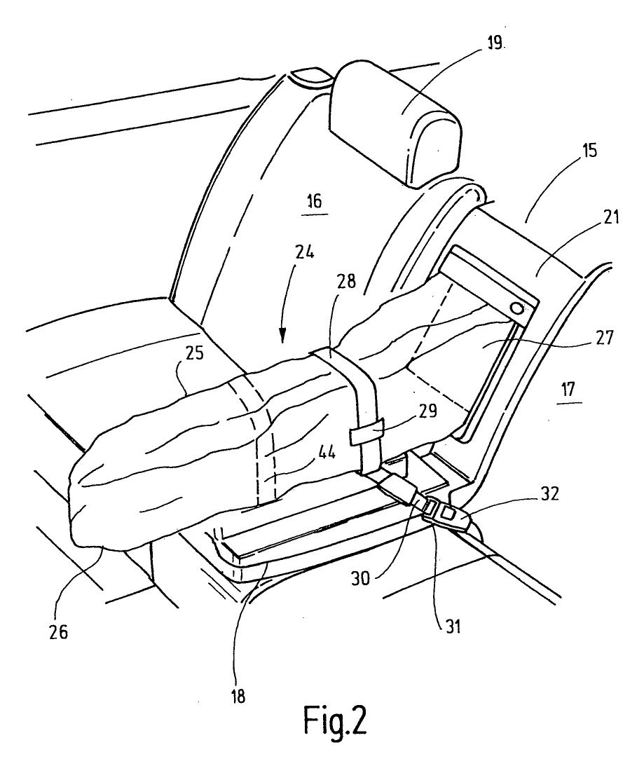

FIG. 2 is an enlarged perspective view of the motor vehicle rear passenger compartment section of FIG. 1 showing the ski bag in its operating position and the mechanism for securing the ski bag in the rear section of the motor vehicle.

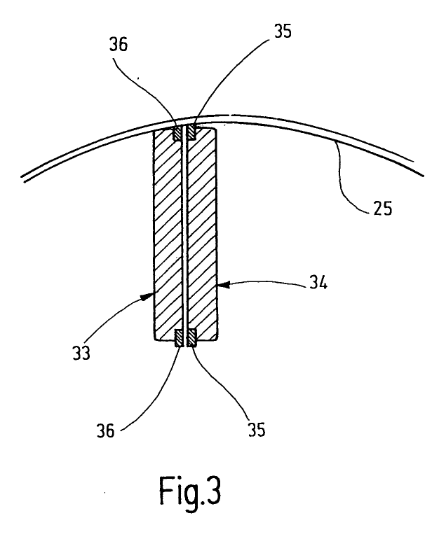

FIG. 3 is a cross-sectional view of the ski bag of FIGS. 1 and 2 showing the contact between the skis and the inner side of the ski bag.

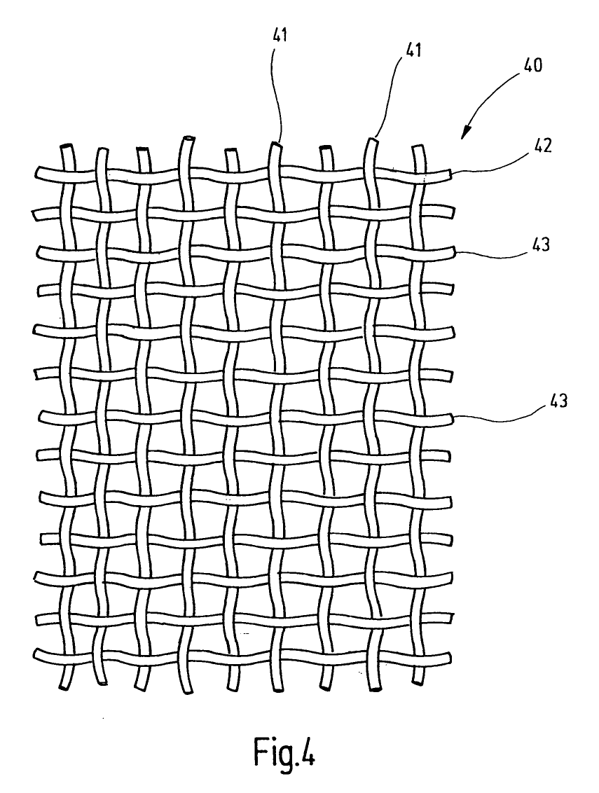

FIG. 4 is an enlarged view of the fabric of the ski bag or the securing belt.

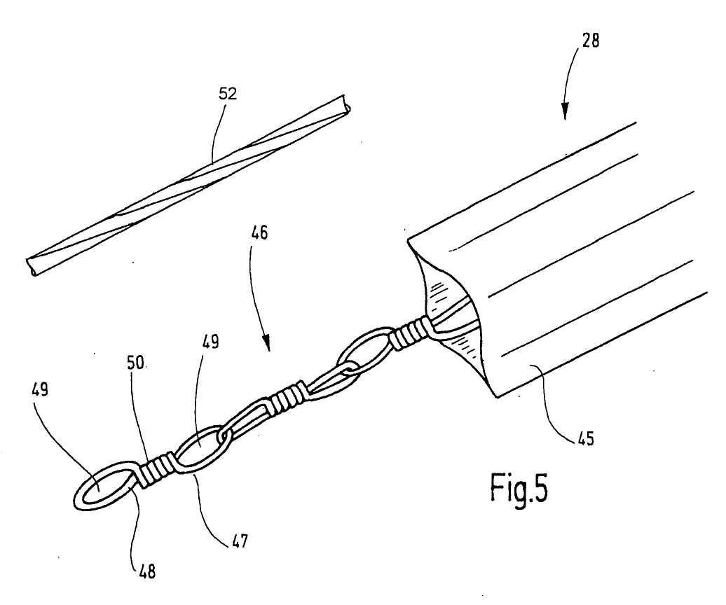

FIG. 5 is a perspective view of an alternative embodiment of the ski bag arrangement according to the invention which includes a tubular belt with a chain inserted therein.

### DETAILED DESCRIPTION OF THE INVENTION

Referring now more specifically to the drawings, FIG. 1 illustrates the rear passenger section of a motor car. The right inner side of the rear passenger section shown in FIG. 1 is a mirror image of the not-shown left inner side. FIG. 1 is simplified in certain respects, e.g., interior structures of the car body such as reinforcing elements, mounting elements and the like are not shown because they are not essential for understanding the invention. The hollow spaces of the car body are also not shown in FIG. 1.

The illustrated car body section 1 includes a roof 2 from which a B-column 3 extends downward to the floor of the vehicle. A corresponding B-column is also provided on the not-shown left side of the vehicle. At its rear edge, the roof 2 transforms into a rear window 4. The rear window 4 ends in the lateral direction at a C-column 5 that is spaced apart from the B-column 3. The C-column 5 also carries an interior lining. In a conventional manner, a right rear side door 7 is hinged to the B-column 3 between the B-column 3 and the C-column 5. The side door 7 includes a conventional window 8 that is divided into a lowerable section 9 and a triangular stationary section 10.

A rear bench seat 11 with a seating surface 12 and a seat back 13 is situated at the height of the right rear side door 7. The rear seating surface 12 is arranged on a pedestal 14 that forms part of the floor of the vehicle and contains leg room areas. A rear window shelf 15 is situated slightly underneath the upper edge of the rear seat back 13 and extends to the lower edge of the rear window 4. The rear seat back 13 is divided into a right seat back section 16 and a left seat back section 17 that are spaced apart from one another by a certain distance as shown. A seat back section 18 is arranged in this intermediate space. The lower edge of the intermediate seat back section 18 is hinged such that it can be moved between the horizontal position shown and an upright position in which it connects the two seat back sections 16, 17 to one another in order to create a third emergency seat. Headrests 19 and 20 are arranged on the upper edges of the seat back sections 16 and 17.

In the illustrated embodiment, a mounting arrangement 21 with a ski bag box 22 inserted therein is situated in the region that is normally covered by the central seat back section 18. The mounting arrangement 21 is rigidly connected to the car body. For example, the mounting arrangement can be accommodated in the structure for the right seat back section 16 as is presently common practice in motor vehicles.

The ski bag box 22 generally consists of a cuboid shaped box. The front side of the ski bag box 22 has a cover 23 that is hinged on its lower end. A second hinged cover closes the rear side of the ski bag box 22 in the direction of the cargo area or trunk situated behind the rear seat back 13. When the front cover 23 is pivoted downward, a ski bag 24 can be pulled into the passenger compartment as shown in FIG. 2. The ski bag 24 consists of a bag casing 25 that is closed on the bottom 26. The end of the bag casing 25 opposite the bottom 26 is anchored within a frame-shaped base body. At this end, the ski bag 24 opens in the direction of the cargo area or trunk via an insertion opening 27.

To prevent the ski bag 24 with the skis stowed therein from being thrown about uncontrollably, a belt 28 is provided that extends through loops 29 sewn to the ski bag casing 25 and is connected to straps 30. The free ends of the straps 30 carry latch elements 31 that are designed for insertion into the buckles 32 of the rear bench seat belts.

FIG. 3 illustrates a situation where a pair of skis have been stowed in the ski bag 24 from the direction the trunk or cargo area. In FIG. 3, the skis 33 and 34 are diagrammatically depicted in a cross-sectional view. The skiing surfaces of the skis flatly adjoin one another. The steel edges 35 and 36 of the skis laterally protrude from the base bodies of the skis 33 and 34 in the area of the skiing surfaces. These steel edges 35 and 36 are quite sharp. The steel edges 35 and 36 adjoin the inner side of the bag casing 25 in a relatively tight fashion, particularly in the area of the belt 28. This situation is schematically illustrated in FIG. 3. The belt 28 can be tightened in order to securely stow and fix the sections of the skis that protrude into the passenger compartment.

Due to the high forces that occur during a crash as a result of the unavoidable longitudinal movement, there is a risk that the steel edges 35, 36 of the skis 33, 34 will cut open the bag casing 25 and also sever the belt 28. The opening that is created forms a passage into the passenger compartment and makes it possible for parts situated in the cargo area to be thrown into the passenger compartment. In the worst-case scenario, the skis 33, 34 can be thrown into the passenger compartment through this opening and severely injure the passengers.

In order to prevent this situation, the bag casing 25 and/or the belt 28 can be provided with a reinforcing element. The reinforcing element is configured such that it cannot be cut by the steel edges 35, 36 in the event of a crash in which the occurring acceleration forces are not significantly above the typical values encountered in prescribed crash tests. FIGS. 4 and 5 illustrate different embodiments of such a ski bag. In the first embodiment, the ski bag 25 is made of the fabric 40 shown in FIG. 4. The fabric 40 consists of a plasticized fabric in the form of a linen weave with warp threads 41 and weft threads 42. Most of the weft threads 42 consist of synthetic monofilaments, for example, polyester monofilaments. However, this material is generally not sufficiently resistant to being cut. In order to achieve the required cutting resistance, a few weft threads 43 of Kevlar (registered trade name) can be incorporated into the fabric. These fibers are extremely strong and cannot be severed by the steel edges 35 and 36 in case of a crash if they have a predetermined diameter or are provided in predetermined numbers. In this embodiment, the warp threads 41 can extend in the longitudinal direction of the ski bag casing 25, i.e., from the insertion box 22 to the bottom 26, and that the weft threads 42 are oriented in the circumferential direction of the bag casing 25.

Another option for securing the skis consists of reinforcing the belt 28. The belt 27 generally consists of a polyester fabric. Accordingly, the belt 28 could become torn or cut during a crash. However, the belt can also contain Kevlar fibers such that it is protected from being severed by the steel edges 35, 36. In this respect, the fabric of the embodiment shown in FIG. 4 can also be applied as the fabric of the belt 28. However, the warp threads customarily extend in the longitudinal direction of the belt 28 and the weft threads extend in the transverse direction in band-shaped or belt-shaped woven objects. In order to achieve the desired effect, in the context of a belt, the threads 42 shown in FIG. 4 symbolize the warp threads and the threads 41 symbolize the weft threads. At least some of the warp threads 42 of the belt 28 consist of Kevlar fibers 43. The cut-resistant reinforcing element consequently extends in the circumferential direction of the ski bag 24 and prevents the ski bag from being cut open in this region.

In the bag casing 25 as well as in the belt 28, the cut-resistant threads in the form of Kevlar monofilaments may lie closely adjacent to one another. Alternatively, the cut-resistant threads may be spaced apart from one another in the form of parallel weft threads if the warp threads extend in the above-described fashion, for example, in the bag casing 25. If the weft and warp threads in the bag casing 25 are oriented differently, i.e., if the weft threads lie in the longitudinal direction of the ski bag 24, it should be understood that warp threads of polyester alternate with warp threads of Kevlar. The Kevlar fibers may also extend tightly adjacent to one another in critical regions of the ski bag or the bag casing, for example, in a zone 44 that is illustrated with broken lines in FIG. 2. The zone 44 is spaced apart from the belt 27 and extends around the bag casing 25 in the circumferential direction. In order to prevent the tips of the skis from piercing the bottom 26, it may also be practical to sew or bond a fabric section 40 that essentially consists of Kevlar fibers only to the inner side of the bottom 26.

FIG. 5 shows an arrangement, in which the reinforcing element of the belt 28 is not achieved with synthetic fibers. The belt 28 shown in FIG. 5 consists of a tubular sleeve 45 of a woven or knitted fabric. A wire link chain 46 longitudinally extends in the interior of this tubular sleeve 45. The individual wire links 47 are designed such that they do not open under tension. For this purpose, the free wire ends of the respective wire sections that form a chain link 47 are coiled around a central section 48 between the chain links 49 as indicated by the reference symbol 50.

Instead of the chain 46, the tubular casing 45 may also contain a Kevlar band, a Kevlar braiding or a wire braiding as indicated by the reference symbol 52 in FIG. 5. The braiding may also be accommodated in a tubular sleeve that is sewn to the ski bag 24.

According to the invention, the reinforcing elements can extend in the circumferential direction of the ski bag 24. These reinforcing elements are resistant to being cut by the steel edges 35, 36 within the relevant range of forces.

The invention was described in connection with a ski bag 24 that is anchored in an opening in the rear seat back 13. However, those skilled in the art will appreciate that this reinforcing element can also be utilized in connection with ski bags that are openly anchored in the cargo area of station wagons, for example, the ski bag disclosed in DE 196 04 714 A1 (the disclosure of which is incorporated herein by reference). In such a case, the belt protects the ski bag, in particular, such that the zipper provided on this type of ski bag cannot be torn open by the skis and the skis are unable to subsequently sever the belt itself.

With respect to the reinforcing element, it should be sufficiently flexible for the unimpaired stowing of the ski bag in the box 22 or in another type of storage receptacle.

The present invention provides a ski bag having a reinforcing element in at least one region. This reinforcing element prevents the steel edges of the skis from cutting open the ski bag in the event of a crash such that parts cannot be thrown into the passenger compartment through the ski bag or the skis cannot be thrown into the passenger compartment through this opening.

1. A ski bag arrangement for stowing skis in a motor vehicle comprising a bag casing comprising a flexible material that includes an insertion opening and a bottom and a reinforcing element that is resistant to being cut by a steel edge of a ski.

2. The ski bag arrangement according to claim 1 wherein the bag casing has sides and the reinforcing element is arranged on each side of the bag casing against which the steel edges of stowed skis are pressed during a crash.

3. The ski bag arrangement according to claim 1 wherein the reinforcing element is arranged in a longitudinal direction of the bag casing.

4. The ski bag arrangement according to claim 1 wherein the reinforcing element is arranged in a circumferential direction of the bag casing.

5. The ski bag arrangement according to claim 1 wherein the reinforcing element is limited to a plurality of regions of the bag casing, the plurality of regions being spaced apart from one another and the axial length of the plurality of regions being smaller than the axial length of the bag casing measured from the bottom to the insertion opening.

6. The ski bag arrangement according to claim 5 wherein the axial length of the plurality of regions is less than 2% of the total axial length of the bag casing.

7. The ski bag arrangement according to claim 1 wherein the reinforcing element comprises of a cut-resistant synthetic fiber that extends in the circumferential direction of the bag casing (25).

8. The ski bag arrangement according to claim 7 wherein the cut-resistant synthetic fiber is incorporated into the bag casing.

9. The ski bag arrangement according to claim 7 wherein bag casing is made of a fabric and the cut-resistant reinforcing element comprising a fiber is incorporated into the fabric of the bag casing.

10. The ski bag arrangement according to claim 1 wherein the bag casing comprises a textile fabric.

11. The ski bag arrangement according to claim 1 wherein the cut-resistant reinforcing element comprises at least one metal chain, one braided metal wire, or one cut-resistant plastic braiding that extends in the circumferential direction of the bag casing.

12. The ski bag arrangement according to claim 1 wherein the reinforcing element is inseparably connected to the bag casing.

13. The ski bag arrangement according to claim 1 wherein the reinforcing element forms part of the bag casing.

14. The ski bag arrangement according to claim 1 wherein a belt is provided for anchoring the ski bag in the motor vehicle, the belt surrounding the ski bag at least partially in the circumferential direction.

15. The ski bag arrangement according to claim 14 wherein the reinforcing element is an integral part of the belt.

16. The ski bag arrangement according to claim 15 wherein the reinforcing element or strengthening comprises a monofilament that is incorporated into the belt.

17. The ski bag arrangement according to claim 15 wherein the reinforcing element comprises at least one metal chain, one braided metal wire, or one cut-resistant plastic braiding that is accommodated in the belt.

18. The ski bag arrangement according to claim 17 wherein a metal chain is accommodated in the belt.
